(19) United States
(12) Patent Application Publication
(10) Pub. No.: US 2021/0064874 A1
(43) Pub. Date: Mar. 4, 2021

(54) HAZARD IDENTIFICATION AND CORRECTION METHOD

(71) Applicant: TOLEDO MUSEUM OF ART, Toledo, OH (US)

(72) Inventors: Adam Levine, Toledo, OH (US); Michael Deetsch, Toledo, OH (US)

(21) Appl. No.: 16/668,021

(22) Filed: Oct. 30, 2019

Related U.S. Application Data
(60) Provisional application No. 62/752,411, filed on Oct. 30, 2018.

(51) Int. Cl. G06K 9/00; G06K 9/32; G06K 9/62; G06T 7/70; G06T 3/60

(52) U.S. Cl. CPC G06K 9/00671; G06K 9/3208; G06T 3/60; G06T 7/70; G06K 9/6202

(57) ABSTRACT

A hazard identification and correction method comprising the steps of viewing a field of view of an environment from a first visual perspective, viewing the field of view of the environment from a second visual perspective, identifying a hazard within the field of view; and correcting the hazard, wherein the viewing step includes directing a gaze of the viewer toward a periphery of the field of view before directing the gaze to spiral radially inwardly toward a center of the field of view and scanning the field of view for areas of high contrast before then scanning the field of view for areas of low contrast.

### CROSS-REFERENCE TO RELATED APPLICATIONS

This application claims the benefit of U.S. Provisional Application No. 62/752,411, filed on Oct. 30, 2018. The entire disclosure of the above application is incorporated herein by reference.

### FIELD

The present technology relates to a method of processing visual stimuli in order to identify and correct otherwise undetected hazards in an environment, and more particularly a work environment.

### INTRODUCTION

This section provides background information related to the present disclosure which is not necessarily prior art.

It has become increasingly common for business entities to proactively address conditions present in a work environment in order to increase efficiency, reduce costs, enhance employee engagement, or the like. Specifically, many business entities may seek to eliminate various hazards that could jeopardize the health or safety of persons interacting within the work environment. However, it has been discovered that personnel responsible for such hazard identification do not typically have the skills necessary for analyzing the visual stimuli presented when reviewing a typical work environment. The lack of such skills may lead to a failure to identify hazards that may otherwise be apparent to a skilled viewer, thereby presenting potential liability for the failure to identify and address the potential hazard.

It would accordingly be beneficial to develop ways to identify hazards for better discovery and correction of potential hazards presented within a work environment, and more specifically within a selected field of view of the hazard identifier.

### SUMMARY

The present technology includes articles of manufacture, systems, and processes that relate to identifying a hazard in an environment and modifying the environment to mitigate the identified hazard.

Ways of identifying a hazard in an environment are provided that include viewing the environment from a first perspective, where the viewing includes: making a first plurality of concentric scans of the environment from the first perspective; locating any portions of the first plurality of scans having high contrast and identifying any hazards therein; and locating any portions of the first plurality of scans having low contrast and identifying any hazards therein. The environment is further viewed from a second perspective, where the viewing includes: making a second plurality of concentric scans of the environment from the second perspective; locating any portions of the second plurality of scans having high contrast and identifying any hazards therein; and locating any portions of the second plurality of scans having low contrast and identifying any hazards therein. The environment is modified to mitigate at least one hazard identified by viewing the environment from the first perspective and by viewing the environment from the second perspective.

Various aspects of the present technology can embody where the first perspective includes a first physical location within the environment, the second perspective includes a second physical location within the environment, and the first physical location is different from the second physical location. The first perspective can include an image of the environment and the second perspective can include a rotation of the image of the environment. Rotation of the image of the environment can be at least about 90 degrees and in certain embodiments can be about 180 degrees. Making the first plurality of concentric scans of the environment from the first perspective can include starting from a periphery of the first perspective and moving toward a center of the first perspective. Likewise, making the second plurality of concentric scans of the environment from the second perspective can include starting from a periphery of the second perspective and moving toward a center of the second perspective. The first plurality of concentric scans of the environment from the first perspective can be made by spiraling inward toward a center of the first perspective and/or the second plurality of concentric scans of the environment from the second perspective can be made by spiraling inward toward a center of the second perspective.

Modifying the environment can include various mitigations to address one or more hazards identified therein. Examples of modifying the environment to mitigate the at least one hazard include one or more of removing the at least one hazard from the environment, repairing the at least one hazard, cordoning off the at least one hazard in the environment, posting visual information in the environment relating to the at least one hazard, contacting a utility service regarding the at least one hazard, contacting a police department regarding the at least one hazard, contacting a fire department regarding the at least one hazard, and contacting a security service regarding the at least one hazard. Examples of hazards include one or more of a fire hazard, an electrical hazard, a water hazard, a tripping hazard, a slipping hazard, a falling hazard, a sharp surface, a source of cold, a source of heat, a toxic chemical source, a security hazard, and combinations thereof.

Certain embodiments of identifying a hazard in an environment can include performing the viewing of the environment from the first perspective and the viewing of the environment from the second perspective by both a first viewer and a second viewer. In this way, the environment can be modified to mitigate at least one hazard identified by viewing the environment from the first perspective and by viewing the environment from the second perspective by one of the first viewer and the second viewer. Alternatively, the environment can be modified to mitigate at least one hazard identified by viewing the environment from the first perspective and by viewing the environment from the second perspective by both of the first viewer and the second viewer.

Further ways of identifying a hazard in an environment can include the following steps. The environment can be viewed from a plurality of perspectives, where the viewing includes: making a plurality of concentric scans of the environment from each perspective; locating any portions of the plurality of scans having high contrast and identifying any hazards therein; and locating any portions of the plurality of scans having low contrast and identifying any hazards therein. The environment can be modified to mitigate at least one hazard identified by viewing the environment from the plurality of perspectives.

Various aspects can embody where making the plurality of concentric scans of the environment from each perspective includes starting from a periphery of each perspective and moving toward a center of each perspective. Viewing the environment from the first perspective and viewing the environment from the second perspective can be performed by both a first viewer and a second viewer such that the environment is modified to mitigate at least one hazard identified by viewing the environment from the first perspective and by viewing the environment from the second perspective by both of the first viewer and the second viewer. The first plurality of concentric scans of the environment from the first perspective can be made by spiraling inward toward a center of the first perspective and/or the second plurality of concentric scans of the environment from the second perspective are made by spiraling inward toward a center of the second perspective.

In certain embodiments, the present technology provides a hazard identification and correction method comprising the steps of viewing a field of view of an environment from a first visual perspective, viewing the field of view of the environment from a second visual perspective, identifying a hazard within the field of view; and correcting the hazard, wherein the viewing step includes directing a gaze of the viewer toward a periphery of the field of view before directing the gaze to spiral radially inwardly toward a center of the field of view and scanning the field of view for areas of high contrast before then scanning the field of view for areas of low contrast.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of the six steps of the Art of Seeing Art™ looking methodology; and

FIG. 2 is a photograph of an environment suitable for hazard identification and correction.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the identification of a hazard in an environment by viewing the environment from a plurality of perspectives, where the viewing includes making a plurality of concentric scans of the environment from each perspective, locating any portions of the plurality of scans having high contrast and identifying any hazards therein, and locating any portions of the plurality of scans having low contrast and identifying any hazards therein. The environment is then modified to mitigate at least one hazard identified by viewing the environment from the plurality of perspectives.

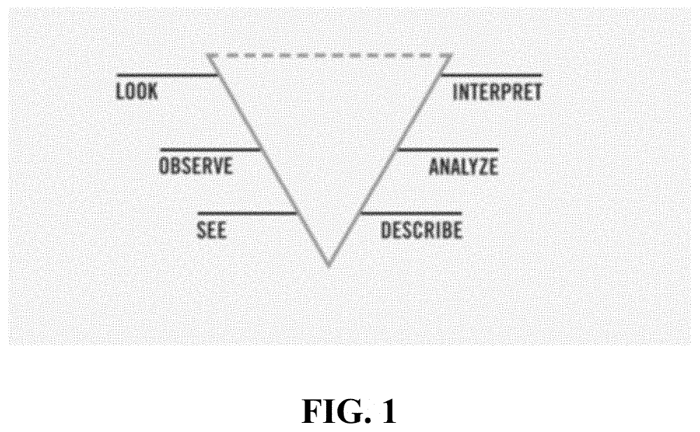

The present technology can be further understood in reference to the following examples and concepts. In particular, one process that is employed in the present technology is termed “The Art of Seeing Art,” which identifies six stages in the process of making meaning out of visual stimuli: (1) Look, (2) Observe, (3) See, (4) Describe, (5) Analyze, (6) Interpret. These six stages or steps can be visualized by the triangular ‘cycle’ illustrated in FIG. 1. Likewise, Seeing the Whole PICTURE is a structured observational approach that was developed to enhance performance across the first three steps of the Art of Seeing Art. These three steps are defined as follows:

Look—Superficial glancing, akin to skimming;

Observe—Intentional looking that leverages close attention to scan a visual field systematically; and

See—A comprehensive inventory of visual field.

Seeing the Whole PICTURE is a mnemonic that is meant to operationalize observational techniques and cause those using it to more effectively move from superficial looking to deeper seeing. The mnemonic that the method leverages is the acronym ‘PICTURE,’ which stands for the following:

‘PI’ stands for ‘Perimeter to Interior’;

‘C’ stands for ‘Contrast’;

‘TU’ stands for ‘Turn it Upside-down’;

‘R’ stands for ‘Repeat’; and

‘E’ stands for ‘Explain’.

Each of these steps is described in more detail below.

Perimeter to Interior

The first step of the method reminds users to scan a visual field from the outside in, moving one's eyes peripherally around the scene in increasingly smaller concentric circles. This approach to looking helps mitigate the inherent bias human beings have towards certain visual elements (e.g., faces) as well as the tendency for pupillary movements, called saccades, to cascade in an unstructured way across a visual field. Moreover, relatively little of any given view is conveyed in high resolution, so the perimeter to interior methodology ensures adequate resolution for the entire visual field.

Contrast

In addition to faces and certain line configurations (T-junctions, Y-junctions, etc.), among the most significant visual biases is the tendency to focus on areas of high contrast. The effect of this bias is not only that high contrast can distract from other parts of the visual field but also that humans are reasonably bad at differentiating elements of a visual field in low-contrast environments. This step in the process reminds users to pay special attention to areas of low contrast.

Turn it Upside-Down

This step in the process is a reminder that people tend to survey visual environments from a single vantage point, both literally and figuratively. By walking around an environment and inspecting a single area from multiple perspectives—or turning a photo of a scene ‘upside-down’—one will identify entirely new elements and facets of the environment. Likewise, because visual understanding emerges from the intersection of vision, cognition, and memory, two individuals will see the same scene differently. As such, this step reminds users to view a scene from multiple vantage points and to conscript others to view the same scene and share their thoughts.

Repeat and Explain

The last two steps are consolidated here for ease. After scanning the visual field from the outside-in, looking closely in areas of low-contrast, viewing the scene from multiple vantage points, and soliciting the opinions of others, one should repeat these steps to make sure all visual biases have been mitigated to the extent possible. Once the foregoing steps have been repeated, a user of Seeing the Whole PICTURE will be able to explain more clearly what s/he sees in his/her visual environment.

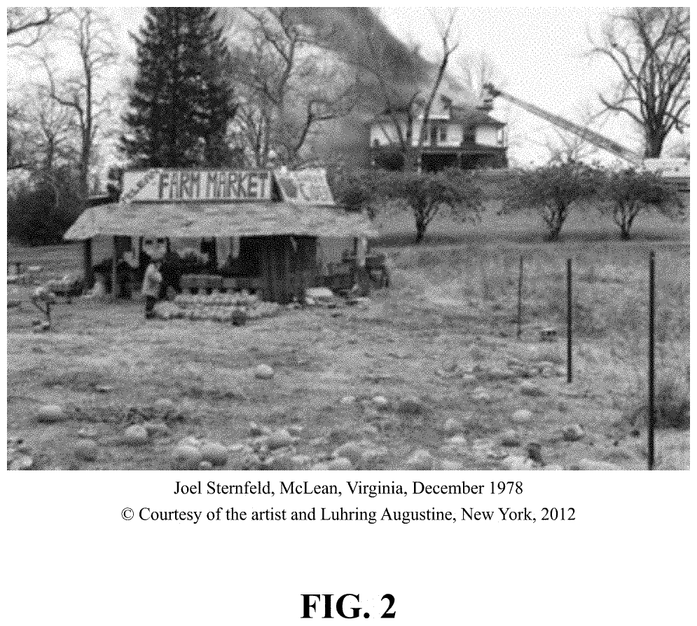

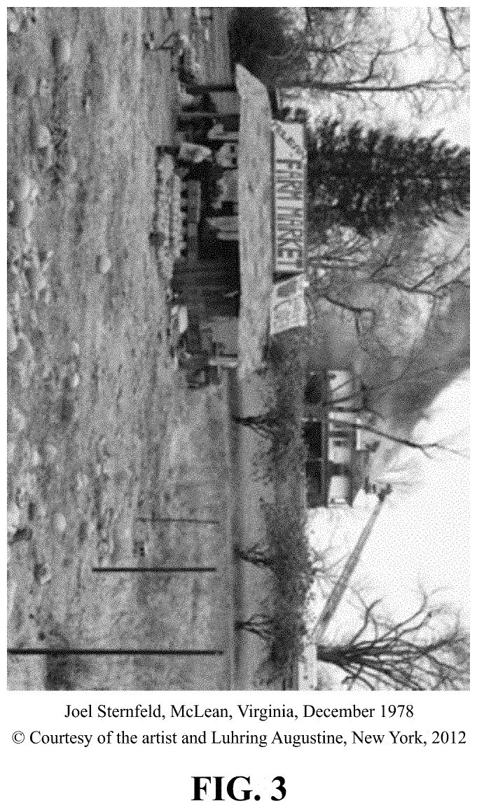

For example, FIG. 2 illustrates a sample environment in need of analysis. In this photograph, roughly 50% of viewers fail to notice the fireman looking at the stacked pumpkins in the midground of the image. The reasons for this failure are twofold. First, most people are drawn immediately to the high contrast between the intense orange flames and the seemingly matte grey sky and also because the fireman's jacket, while different in hue from the pumpkins, is sufficiently similar that the fireman does not stand out. Instead, most viewers begin their visual scan of this image with the conflagration and then allow their eyes to dart around the images to other areas of high contrast (e.g., the yellow farm sign, the green posts, the trees, and the firetruck ladder).

If a viewer applied the Seeing the Whole PICTURE methodology, however, s/he would have noticed the fireman given enough time to scan the image. Using the method, a viewer would have begun his/her visual analysis by gazing at the upper left corner. S/he would have then scanned the top edge of the photograph from left to right, ending up with his/her gaze in the upper right hand corner. From there, the viewer would direct his/her attention down the far right edge to the lower right corner and would continue channeling his/her gaze around the periphery of the image on a complete loop. Once the first cycle around the image has been completed, the process should be repeated in concentric and inwardly spiraling rings until the entire image has been scanned. S/he literally would have scanned the image from the periphery to a central interior portion of the image. Although the fireman may not be registered consciously using this approach, Seeing the Whole PICTURE ensures that the fireman is at least seen and subconsciously processed.

The next step would require the viewer to at first look for areas of high contrast (some of which have been listed above) followed by areas of low contrast; e.g., areas with large masses of homogenous color. The sky, the field, the low-set trees, the interior of the farm stand, and the stack of pumpkins would all qualify. At this point, most viewers would see the fireman.

As a final step, however, viewers would be encouraged to shift their perspective; e.g., ‘turn it upside down’. In the real world, this would involve moving to obtain another vantage point of a scene. In the provided example, one could imagine that by moving to the viewer's right, the fireman would be set against the field and not the pumpkins, thereby rendering him more visible. Alternatively, in the case of a photograph, the image could be rotated to create a different relationship between the image's forms. For example, a 90 degree clockwise rotation of the image of FIG. 2 makes the scene more visible since the human form aligns with the direction that western viewers tend to ‘read’ the scene; e.g, from left to right.

Seeing the Whole PICTURE is designed both as method to improve visual processing accuracy but also to prove visual processing efficiency. As with any physical task, the efficiency and accuracy of looking is improved by practice. As such, viewers are encouraged to repeat the previous steps and then, finally, explain what they saw, either to colleagues in a conversation or by recording their findings in a report.

The Seeing the Whole PICTURE methodology may be adapted for identifying essentially any type of hazard that may be found within a field of view of an environment as taken from the perspective of the hazard identifier. The field of view may represent a visual field of the user with respect to the environment or the field of view may represent an image or graphical representation of the environment. The hazards may relate to the safety of an employee, a customer, or any person interacting with the environment. The hazards may relate to potentially dangerous features of the environment such as a sharp surfaces, tripping hazards, slipping hazards, sources of excessive heat or cold, potential locations of mechanical or structural failure, sources of toxic chemicals, sources of noxious odors, potential security flaws, potential ergonomic hazards, or the like, as non-limiting examples. The hazards generally relate to any feature of the environment in need of modification that may be ascertained via visual inspection of the environment from at least one field of view.

Referring again to FIG. 2, one potential hazard in need of identification may relate to intruders or persons otherwise not given permission to access the environment in question. For example, the image as shown in FIG. 2 may be assumed to be a field of view of the environment as seen from the perspective of a security guard or a device utilized by the security guard, such as an image generated by a security camera being reviewed by the security guard, for detecting persons that have improperly entered the environment. In the given example, it can be assumed that the fireman is not given permission to enter the environment and accordingly represents the hazard in need of identification. As explained hereinabove, the user will eventually locate the hazard using the disclosed steps of scanning the field of view from the perimeter to the interior, scanning the field of view for varying degrees of contrast, and changing the perspective of the field of view. Once identified, the environment may be physically transformed in order to remove or modify the identified hazard. In the current example, the intruder in the form of the fireman may be physically removed from the environment to eliminate the hazard.

Referring again to FIG. 2, in a secondary example the hazard in need of identification may be tripping hazards found on the ground of the environment, and more specifically the pumpkins found on the ground. As can be seen in FIG. 2, the pumpkins are largely found in the bottom third of the image and include darker pumpkins having a great degree of contrast with the surrounding green portions of grass and brown portions of grass and lighter pumpkins having a low degree of contrast with the brown portions of grass. The hazard identifier first scans the field of view from the perimeter to the interior to ensure that the entirety of the field of view if visually analyzed. Next, the identifier looks for areas of great contrast and low contrast to determine if any features become apparent. In the given example, the analysis of the differing degrees of contrast between the brown grass color, the green grass color, the light pumpkin color, and the dark pumpkin color should reveal at least some of the tripping hazards. The identifier may then alter the perspective at which the environment is viewed, such as rotating the image relative to the perspective shown in FIG. 2. Alternatively, the changing of the field of view may include the identifier physically moving within the environment to change the field of view of the environment. In the given example, such movement about the environment may beneficially reveal new perspectives to view the tripping hazards such as revealing new angles at which the grass of varying heights no longer obscures visual access to the identified hazards. Once all tripping hazards are identified the pumpkins may be physically removed from the environment in order to correct the identified hazard.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method for identifying a hazard in an environment, the method comprising:
viewing the environment from a first perspective, where the viewing includes:
making a first plurality of concentric scans of the environment from the first perspective;
locating any portions of the first plurality of scans having high contrast and identifying any hazards therein; and
locating any portions of the first plurality of scans having low contrast and identifying any hazards therein;
viewing the environment from a second perspective, where the viewing includes:
making a second plurality of concentric scans of the environment from the second perspective;
locating any portions of the second plurality of scans having high contrast and identifying any hazards therein; and
locating any portions of the second plurality of scans having low contrast and identifying any hazards therein;
modifying the environment to mitigate at least one hazard identified by viewing the environment from the first perspective and by viewing the environment from the second perspective.

2. The method of claim 1, wherein the first perspective includes a first physical location within the environment, the second perspective includes a second physical location within the environment, the first physical location being different from the second physical location.

3. The method of claim 1, wherein the first perspective includes an image of the environment and the second perspective includes a rotation of the image of the environment.

4. The method of claim 3, wherein the rotation of the image of the environment is at least about 90 degrees.

5. The method of claim 3, wherein the rotation of the image of the environment is about 180 degrees.

6. The method of claim 1, wherein making the first plurality of concentric scans of the environment from the first perspective includes starting from a periphery of the first perspective and moving toward a center of the first perspective.

7. The method of claim 1, wherein making the second plurality of concentric scans of the environment from the second perspective includes starting from a periphery of the second perspective and moving toward a center of the second perspective.

8. The method of claim 1, wherein:
making the first plurality of concentric scans of the environment from the first perspective includes starting from a periphery of the first perspective and moving toward a center of the first perspective; and
making the second plurality of concentric scans of the environment from the second perspective includes starting from a periphery of the second perspective and moving toward a center of the second perspective.

9. The method of claim 1, wherein the first plurality of concentric scans of the environment from the first perspective are made by spiraling inward toward a center of the first perspective.

10. The method of claim 1, wherein the second plurality of concentric scans of the environment from the second perspective are made by spiraling inward toward a center of the second perspective.

11. The method of claim 1, wherein:
the first plurality of concentric scans of the environment from the first perspective are made by spiraling inward toward a center of the first perspective; and
the second plurality of concentric scans of the environment from the second perspective are made by spiraling inward toward a center of the second perspective.

12. The method of claim 1, wherein modifying the environment to mitigate the at least one hazard includes a member selected from a group consisting of: removing the at least one hazard from the environment, repairing the at least one hazard, cordoning off the at least one hazard in the environment, posting visual information in the environment relating to the at least one hazard, contacting a utility service regarding the at least one hazard, contacting a police department regarding the at least one hazard, contacting a fire department regarding the at least one hazard, contacting a security service regarding the at least one hazard, and combinations thereof.

13. The method of claim 1, wherein the at least one hazard includes a member selected from a group consisting of: a fire hazard, an electrical hazard, a water hazard, a tripping hazard, a slipping hazard, a falling hazard, a sharp surface, a source of cold, a source of heat, a toxic chemical source, a security hazard, and combinations thereof.

14. The method of claim 1, wherein:
viewing the environment from the first perspective and viewing the environment from the second perspective are performed by both a first viewer and a second viewer; and
modifying the environment to mitigate at least one hazard identified by viewing the environment from the first perspective and by viewing the environment from the second perspective by one of the first viewer and the second viewer.

15. The method of claim 1, wherein:
viewing the environment from the first perspective and viewing the environment from the second perspective are performed by both a first viewer and a second viewer; and
modifying the environment to mitigate at least one hazard identified by viewing the environment from the first perspective and by viewing the environment from the second perspective by both of the first viewer and the second viewer.

16. A method for identifying a hazard in an environment, the method comprising:
viewing the environment from a plurality of perspectives, where the viewing includes:
making a plurality of concentric scans of the environment from each perspective;
locating any portions of the plurality of scans having high contrast and identifying any hazards therein; and
locating any portions of the plurality of scans having low contrast and identifying any hazards therein; and
modifying the environment to mitigate at least one hazard identified by viewing the environment from the plurality of perspectives.

17. The method of claim 16, wherein making the plurality of concentric scans of the environment from each perspective includes starting from a periphery of each perspective and moving toward a center of each perspective.

18. The method of claim 17, wherein:
viewing the environment from the first perspective and viewing the environment from the second perspective are performed by both a first viewer and a second viewer; and
modifying the environment to mitigate at least one hazard identified by viewing the environment from the first perspective and by viewing the environment from the second perspective by both of the first viewer and the second viewer.

19. The method of claim 18, wherein the plurality of concentric scans of the environment from each perspective are made by spiraling inward toward a center of the first perspective.

20. The method of claim 19, wherein:
modifying the environment to mitigate the at least one hazard includes a member selected from a group consisting of: removing the at least one hazard from the environment, repairing the at least one hazard, cordoning off the at least one hazard in the environment, posting visual information in the environment relating to the at least one hazard, contacting a utility service regarding the at least one hazard, contacting a police department regarding the at least one hazard, contacting a fire department regarding the at least one hazard, contacting a security service regarding the at least one hazard, and combinations thereof; and
the at least one hazard includes a member selected from a group consisting of: a fire hazard, an electrical hazard, a water hazard, a tripping hazard, a slipping hazard, a falling hazard, a sharp surface, a source of cold, a source of heat, a toxic chemical source, a security hazard, and combinations thereof.
